(19) United States
(12) Patent Application Publication
(10) Pub. No.: US 2007/0176511 A1
(43) Pub. Date: Aug. 2, 2007

(54) Motor and a fuel pump using the same

(75) Inventors: Hiromi Sakai, Nukata-gun (JP); Kiyoshi Nagata, Nagoya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/656,935

(22) Filed: Jan. 24, 2007

(30) Foreign Application Priority Data
Feb. 2, 2006 (JP) 2006-25569
Feb. 10, 2006 (JP) 2006-33509

(51) Int. Cl. H02K 5/12; H02K 1/28; H02K 1/12

(52) U.S. Cl. 310/218; 310/259; 417/423.3; 310/87

(57) ABSTRACT

A motor includes a stator core, insulators, coils and a rotor. The stator core includes a plurality of coil cores, which are circumferentially arranged, wherein each of the plurality of coil cores includes a tooth that radially extends, and an outer peripheral core that circumferentially extends at a radially outer side of the tooth. Each of the insulators covers a corresponding one of the plurality of coil cores, wherein a part of each of the insulator is provided radially outward of an imaginary straight line, which connects circumferential ends of an inner peripheral surface of the outer peripheral core. Each of the coils is formed at the insulator. The rotor is rotatably provided to an inner peripheral side of the stator core.

### CROSS REFERENCE TO RELATED APPLICATION

This application is based on and incorporates herein by reference Japanese Patent Application No. 2006-33509 filed on Feb. 10, 2006 and Japanese Patent Application No. 2006-25569 filed on Feb. 2, 2006.

### BACKGROUND OF THE INVENTION

1. Field of the Invention

The present invention relates to an inner rotor brushless motor and a fuel pump using the same.

2. Description of Related Art

Conventionally, a fuel pump, which uses the inner rotor brushless motor as a driving source, is disclosed (see e.g., JP-A-2005-110478 corresponding to US 2005/0074343 A1, JP-A-2005-110477). In the brushless motor, there are not generated problems of loss similar to the brush motor due to a frictional resistance between a commutator and a brush, an electric resistance between the commutator and the brush, and a flow resistance applied to grooves provided for dividing the commutator into segments. As a result, motor efficiency of the brushless motor is higher than the brush motor, thereby improving efficiency of the fuel pump. Here, the efficiency of the fuel pump is indicated by (motor efficiency)×(pump efficiency). When I means a drive current provided to the motor of the fuel pump, V means an applied voltage, T means a torque of the motor, N means a rotational speed of the motor, P means a fuel pressure pumped by the fuel pump, and Q means a fuel pump amount, the motor efficiency and the pump efficiency are described as (motor efficiency)=(T×N)/(I×V) and (pump efficiency)=(P×Q)/(T×N). Thus, (efficiency of the fuel pump)=(motor efficiency)×(pump efficiency)=(P×Q)/(I×V).

Then, the fuel pump using the brushless motor can be decreased in size because the motor can be decreased in size for the equivalent motor efficiency in a case where brushless motor is used rather than the brush motor.

Inventors of the present application study a structure of the inner rotor brushless motor for easily winding a winding wire of the coil with a high space factor in a limited winding space of each coil core due to the decrease in size of the motor by using a stator core, in which an outer periphery of rotor is surrounded with multiple coil cores provided radially. Here, the space factor is a ratio of an occupational sectional area of the winding wire relative to the winding space. In other words, when the space factor is higher, the number of turns of the winding wire in the winding space can be increased, therefore downsizing the motor and improving the motor efficiency.

Then, in a coil core 300, which constitutes a stator core and is shaped as shown in FIG. 9, an inner peripheral surface 305 of an outer peripheral core 304 extends circumferentially at a radially outer side of a tooth 302 of a coil core 300, and is positioned generally on an imaginary straight line 330, which runs through circumferential ends of the inner peripheral surface 305. Then, an outer peripheral core 304 side of a coil winding surface 312 of an insulator 310, on which a coil 320 is wound, extends along the imaginary straight line 330. When the outer peripheral core 304 side of the coil winding surface 312 of the insulator 310 extends along the imaginary straight line 330 as above, the winding wire can be easily wound in the winding spaces of the insulator 310 from openings of the insulator 310.

Then, in a coil core 300, which constitutes a stator core and is shaped as shown in FIG. 9, an inner peripheral surface 305 of an outer peripheral core 304 is a flat surface, and the outer peripheral core 304 circumferentially extends at a radially outer side of a tooth 302. Also, an imaginary straight line 330, which connects between circumferential ends of the inner peripheral surface 305, is located on the inner peripheral surface 305. Then, an outer peripheral core 304 side of a coil winding surface 312 of the insulator 310, on which a coil 320 is wound, is a flat surface along the imaginary straight line 330. When the outer peripheral core 304 side of the coil winding surface 312 of the insulator 310 is the flat surface along the imaginary straight line 330 as above, the winding wire can be easily wound in the winding spaces of the insulator 310 from openings of the insulator 310.

However, when the winding wire is wound in the limited winding space by a predetermined number of turns, the coil 320 may reach close to the opening of the insulator 310, and therefore circumferentially adjacent coils may be located close to each other or may contact with each other due to the decrease in size of the motor. Thus, insulation fault between the coils may occur. Also, in order to improve the motor efficiency, the number of turns of the winding wire is supposed to be increased, and for this purpose, a larger winding space is required. Therefore, it is needed that the motor is downsized and at the same time the winding space for the winding wire is increased.

### SUMMARY OF THE INVENTION

The present invention is made in view of the above disadvantages. Thus, it is an objective of the present invention to address at least one of the above disadvantages.

To achieve the objective of the present invention, there is provided a motor, which includes a stator core, insulators, coils, and a rotor. The stator core includes a plurality of coil cores, which are circumferentially arranged. Each of the plurality of coil cores includes a tooth that radially extends, and an outer peripheral core that circumferentially extends at a radially outer side of the tooth. Each of the insulators covers a corresponding one of the plurality of coil cores, wherein a part of each of the insulator is provided radially outward of an imaginary straight line, which connects circumferential ends of an inner peripheral surface of the outer peripheral core. Each of the coils is formed by winding a winding wire at an outer periphery of a corresponding one of the insulators, wherein a magnetic pole, which is circumferentially formed at a radially inner side of each of the plurality of coil cores, is switched when energization of a corresponding one of the coils is controlled. The rotor is rotatably provided to an inner peripheral side of the stator core, wherein different magnetic poles are alternately arranged in a rotational direction on an outer peripheral surface of the rotor, and the outer peripheral surface of the rotor faces the stator core.

To achieve the objective of the present invention, there is also provided a fuel pump, which includes the above motor and a pump that is driven by the motor, wherein the pump takes in fuel and increases pressure of the fuel.

To achieve the objective of the present invention, there is also provided a motor, which includes a stator core, insulators, coils, and a rotor. The stator core includes a plurality of coil cores, which are circumferentially arranged. Each of the plurality of coil cores includes a tooth that radially extends, and an outer peripheral core that circumferentially extends at a radially outer side of the tooth. Circumferential ends of an inner peripheral surface of the outer peripheral core are more tilted radially inwardly relative to an imaginary straight line that connects the circumferential ends of the inner peripheral surface of the outer peripheral core as the circumferential ends approach circumferentially adjacently arranged coil cores. Each of the insulators covers a corresponding one of the plurality of coil cores, wherein an outer peripheral core side of a coil winding surface of each of the insulators extends generally along the imaginary straight line. Each of the coils is wound on a corresponding one of the insulators. The rotor is rotatably provided to an inner peripheral side of the stator core, wherein different magnetic poles are alternately arranged in a rotational direction on an outer peripheral surface of the rotor, and the outer peripheral surface of the rotor faces the stator core.

To achieve the objective of the present invention, there is also provided a fuel pump, which includes the above motor and a pump that is driven by the motor, wherein the pump takes in fuel and increases pressure of the fuel.

To achieve the objective of the present invention, there is also provided a motor, which includes a stator core, insulators, coils, and a rotor. The stator core includes a plurality of coil cores that are circumferentially arranged, wherein each of the plurality of coil cores includes a tooth that radially extends, and an outer peripheral core that circumferentially extends at a radially outer side of the tooth. A tooth side of an inner peripheral surface of the outer peripheral core is recessed radially outwardly relative to an imaginary straight line that connects the circumferential ends of the inner peripheral surfaces of the outer peripheral core as the circumferential ends approach circumferentially adjacently arranged coil cores. Each of the insulators covers a corresponding one of the plurality of coil cores, wherein an outer peripheral core side of a coil winding surface of each of the insulators extends generally along the imaginary straight line. Each of the coils is wound on a corresponding one of the insulators. The rotor is rotatably provided to an inner peripheral side of the stator core, wherein different magnetic poles are alternately arranged in a rotational direction on an outer peripheral surface of the rotor, and the outer peripheral surface of the rotor faces the stator core.

To achieve the objective of the present invention, there is also provided a fuel pump, which includes the above motor, and a pump that is driven by the motor, wherein the pump takes in fuel and increases pressure of the fuel.

### BRIEF DESCRIPTION OF THE DRAWINGS

The invention, together with additional objectives, features and advantages thereof, will be best understood from the following description, the appended claims and the accompanying drawings in which:

FIG. 1A is a sectional view showing a coil core and an insulator of a first embodiment;

FIG. 1B is a figure of a motor, in which a rotor is removed, viewed from one longitudinal end side;

FIG. 2 is a sectional view showing a fuel pump of the present embodiment;

FIG. 3A is an explanatory view showing a winding process of a coil;

FIG. 3B is a partial sectional view of FIG. 3A viewed from a direction IIIB;

FIG. 4 is a sectional view showing a coil core and insulators of a second embodiment;

FIG. 5 is a sectional view showing a coil core and an insulator of a third embodiment;

FIG. 6A is a sectional view showing a coil core and an insulator of a fourth embodiment;

FIG. 6B is a figure of a motor, in which a rotor is removed, viewed from one longitudinal end side;

FIG. 7 is a sectional view showing a fuel pump of the fourth embodiment;

FIG. 8A is an explanatory view showing a winding process of a coil;

FIG. 8B is a partial sectional view of FIG. 8A viewed from a direction VIIIB; and

FIG. 9 is a sectional view showing a coil core and an insulator of a prior art.

### DETAILED DESCRIPTION OF PREFERRED EMBODIMENTS

Hereinafter, multiple embodiments of the present invention will be described with reference to drawings.

### First Embodiment

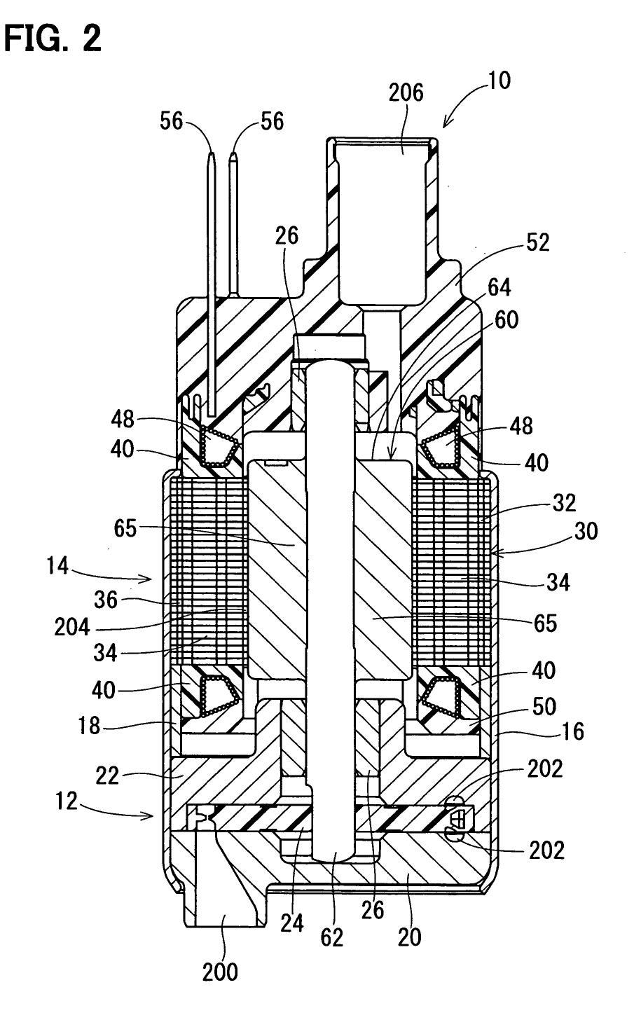

A fuel pump, which uses a motor of the first embodiment of the present invention, is shown in FIG. 2. A fuel pump 10 of the present embodiment is, for example, an in-tank type turbine pump provided in a fuel tank of a two-wheeled vehicle with a cylinder capacity of equal to or less than 150 cc.

The fuel pump 10 includes a pump 12 and a motor 14, which rotationally drives the pump 12. A housing of the fuel pump 10 is configured by housings 16,18. Each of the housings 16, 18 is formed into a cylindrical shape by press-working sheet metal, and the housing 18 is press-fitted into the housing 16 and is fixed thereto. The housing 16 also serves as a housing for the pump 12 and the motor 14, and is designed to have a thickness of about 0.5 mm. Both longitudinal end portions of the housing 16 caulks a pump case 20 and a stator core 30 to fix them. A pump case 22 and the stator core 30 are pressed against longitudinal ends of the housing 18 such that longitudinal positions thereof are determined.

The pump 12 is a turbine pump having the pump cases 20, 22, and an impeller 24. The pump case 22 is press-fitted into the housing 16, and is pressed against the housing 18 in a longitudinal direction. The pump cases 20, 22 are pump cases, which receives the impeller 24 as a rotatable member such that the impeller 24 is rotatable. A pump passage 202, which has a C shape, is provided at each clearance between the impeller 24 and each of the pump cases 20, 22. A pressure of fuel, which is taken through an intake port 200 provided at the pump case 20, is increased in the pump passage 202 by the rotation of the impeller 24 and then the fuel is pumped toward the motor 14. The fuel pumped to the motor 14 flows through a fuel passage 204 located between the stator core 30 and a rotor 60 and then is supplied to an engine through a discharge port 206.

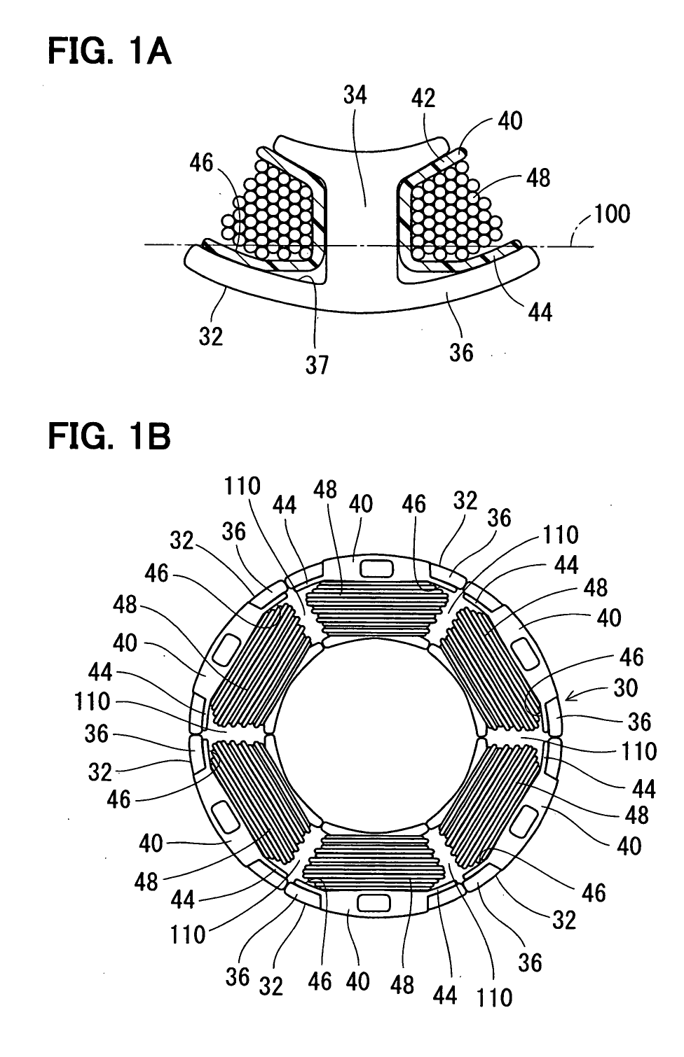

The motor 14 is a so-called brushless motor of an inner rotor type. The motor 14 includes the stator core 30, insulators 40, and coils 48. As shown in FIG. 1, the stator core 30 is configured by six coil cores 32, which are each separated and are circumferentially arranged at regular intervals. The coil core 32 is formed by mutually caulking magnetic steel plates, which are stacked in the longitudinal direction. The coil core 32 includes a tooth 34, which radially extends, and an outer peripheral core 36, which extends in both circumferential directions from a radially outer side of the tooth 34. The outer peripheral core 36 has a uniform thickness and has an arcuate shape. A tooth 34 side of an inner peripheral surface 37 of the outer peripheral core 36 is positioned radially outward of the imaginary straight line 100, which connects circumferential ends of the inner peripheral surface 37.

A pair of insulators 40, which are formed to have substantially the same shape, are fitted with a corresponding coil core 32 from both longitudinal ends thereof, so that the pair of the insulators are mounted on the coil core 32. Each insulator 40 has inner collar 42 on a radially inner side thereof, and outer collars 44 on a radially outer side thereof to form a winding space defined between the inner collar 42 and the outer collar 44 as shown in FIG. 1A. For example, the inner collars 42 and the outer collars 44 are provided on opposite circumferential sides of the tooth 34 as shown in FIG. 1A. The coil 48 is formed by winding the winding wire in this winding space. The outer collar 44 is provided at an outer peripheral core 36 side of the insulator 40. Circumferential end sides of the coil winding surface 46, which are radially inner surfaces of the collars 44, have arcuate shapes, which extend along the outer peripheral core 36. The tooth 34 side of the coil winding surface 46 extends along the imaginary straight line 100. The coil 48 is formed by a concentrated and normal winding of the winding wire on the insulator 40 of each coil core 32.

As shown in FIG. 2, dielectric resin material 50 covers the stator core 30, the insulators 40, and the coils 48 except for a radially inner surface and a radially outer surface of the stator core 30. An end cover 52 is integrally resin molded with the dielectric resin material 50 to form the discharge port 206. The terminals 56, which are exposed from the end cover 52 and is insert-molded therewith, are electrically connected with the coils 48.

The rotor 60 includes a shaft 62 and a permanent magnet 64, and is provided inside the stator core 30 such that the rotor 60 is rotatable. Both end portions of the shaft 62 are rotatably supported by bearings 26. The permanent magnet 64 is a plastic magnet, which is made by incorporating magnetic powders into thermoplastic resin, such as a polyphenylene sulfide (PPS), and a polyacetal (POM), to form a cylindrical shape. The permanent magnet 64 has eight magnetic portions 65 in a rotational direction. The eight magnetic portions 65 are polarized such that different magnetic poles are alternately formed in the rotational direction on outer peripheral surface sides thereof, which face the coil cores 32.

Next, a winding process for winding the winding wire, which forms the coil 48, will be described.

(1) Firstly, the coil core 32 is formed by mutually caulking magnetic steel plates, which are stacked in the longitudinal direction.

(2) The insulators 40 are fitted with the corresponding coil core 32 from both longitudinal direction end sides of the coil core 32 for assembly.

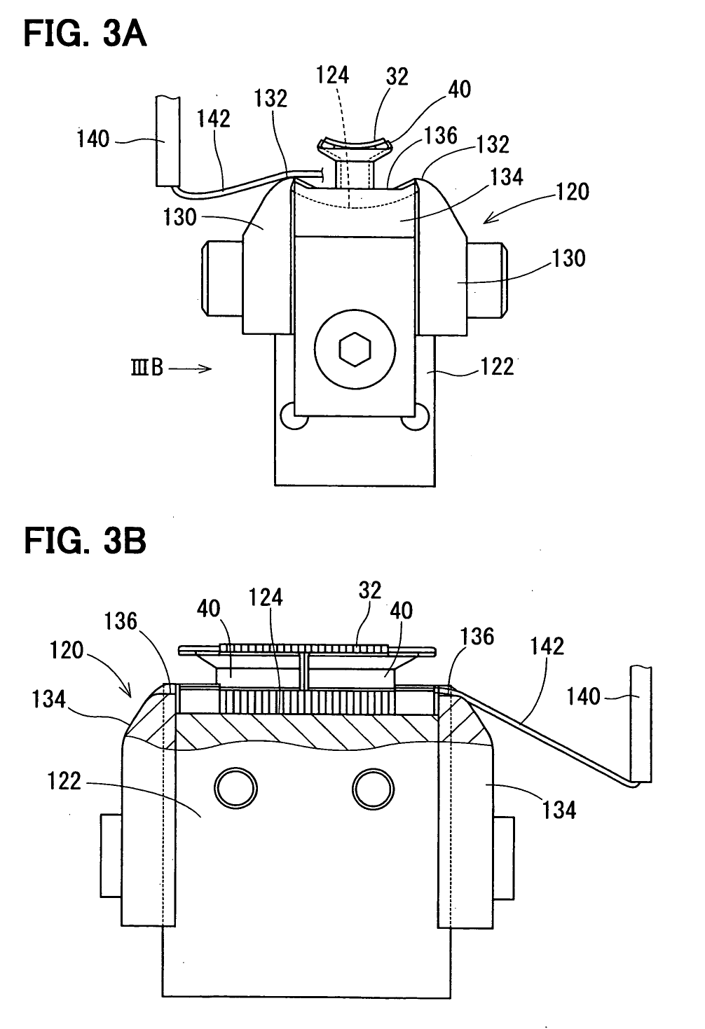

(3) The coil core 32, which is assembled with the insulators 40, is mounted on a base 122 of a winding apparatus 120 shown in FIGS. 3 in a condition where the outer peripheral core 36 faces downward. A mounting surface 124 of the base 122, on which the coil core 32 is mounted, has a recessed arcuate surface, which corresponds to a protruding arcuate surface of the outer peripheral surface of the outer peripheral core 36. Guides 130 are fixed on both transverse end sides of the base 122, and guides 134 are fixed on both longitudinal end sides of the base 122. A guide surface 132 on a top end of the guide 130 extends straightly in the longitudinal direction of the coil core 32, and is formed to have a smooth protruding curved surface to a winding wire 142 in order to guide the winding wire 142. Also, a guide surface 136 on a top end of the guide 134 has a shape, which generally extends along the coil winding surface 46 of the insulator 40. In other words, circumferential sides of the guide surface 136 extends along the arc of the circumferential sides of the coil winding surface 46 of the insulator 40, and also, a middle of the guide surface 136 extends generally along the tooth 34 side of the coil winding surface 46 of the insulator 40. Also, the guide surface 136 is formed to have a smooth protruding curved surface to the winding wire 142 in order to guide the winding wire 142.

(4) After mounting the coil core 32 assembled with the insulators 40 on the base 122, the a nozzle 140, which supplies the winding wire 142, is brought close to the coil core 32.

(5) Then, as shown in FIG. 3A, in a condition where the winding wire 142 is kept under tension in contact with the guide surface 132 on the top end of the guide 130, the nozzle 140 is moved in the longitudinal direction of the coil core 32. When the nozzle 140 reaches one longitudinal end side of the coil core 32, the winding wire 142 is moved from the guide surface 132 of the guide 130 to the guide surface 136 of the guide 134.

(6) At this time, the nozzle 140 is moved from one circumferential end of the guide surface 136 toward the tooth 34 in a condition where the winding wire 142 is kept under downward tension. Then, the nozzle 140 is temporally stopped or moved slowly around the tooth 34. In this way, the winding wire 142 can be pushed toward the tooth 34 side of the coil winding surface 46 of the insulator 40. Here, the tooth 34 side of the coil winding surface 46 of the insulator 40 is located radially outward of the circumferential ends of the outer peripheral core 36 side of the coil winding surface 46 relative to the imaginary straight line 100.

Also, when the winding wire is wound in the winding space of the insulator 40, which is located radially inward of the circumferential ends of the outer peripheral core 36 side of the coil winding surface 46 relative to the imaginary straight line 100, the winding wire is wound through the normal winding in a condition where the winding wire 142 is not pressed against the guide surface 136. In this way, the winding wire 142 is wound on the insulator 40, which is assembled to each coil core 32, through the concentrated and normal winding.

In the above described first embodiment, the outer peripheral core 36 of the coil core 32 has a uniform thickness, and the tooth 34 side of the inner peripheral surface 37 is positioned radially outward of the imaginary straight line 100, which connects the circumferential ends of the inner peripheral surface 37 of the outer peripheral core 36. As a result, the coil core 32 is not formed at an unnecessary portion (e.g., a tooth 302 side of the outer peripheral core 304 of the coil core 300 of the conventional art shown in FIG. 9) for the magnetic circuit, but a part of the insulator 40 is provided instead. In this way, the coil core 32 is decreased in size, and at the same time, the winding space defined by the insulator 40 is increased. In other words, in the present embodiment, the tooth side of the inner peripheral surface of the outer peripheral core is positioned radially outer side of the imaginary straight line, which connects both circumferential ends of the inner peripheral surface of the outer peripheral core, and therefore is thinner.

Therefore, if the number of turns of the winding wire 142 is identical, the positions of circumferential ends of the wound coil 48 can be moved and brought closer to the tooth 34. Typically, circumferential end faces of the wound coil 48 are recessed toward the tooth 34. As a result, as shown in FIG. 1B, because a clearance 110 defined between circumferentially adjacently arranged coils 48 becomes larger, the dielectric performance between the coils 48 can be attained.

Also, because the tooth side of the outer peripheral core side of the coil winding surface of the insulator is positioned radially outward of the imaginary straight line, the winding space is increased. Thus, by making the unnecessary portion for the magnetic circuit thinner, the winding space can be increased without degrading a magnetic performance. Specifically, because the winding space of the insulator 40 becomes larger, the circumferentially adjacently arranged coils are limited from being located excessively close to each other and still the number of turns can be increased. Thus, the motor efficiency can be improved.

Also, because the tooth side of the coil winding surface 46 of the outer collar of the insulator 40 is the flat surface, which extends along the imaginary straight line 100, the winding wire can be easily wound along the coil winding surface 46 in a state where a fault winding at the back of the winding space of the insulator 40 is limited. In one embodiment, when the fault winding occurs, the coil collapses.

### Second and Third Embodiments

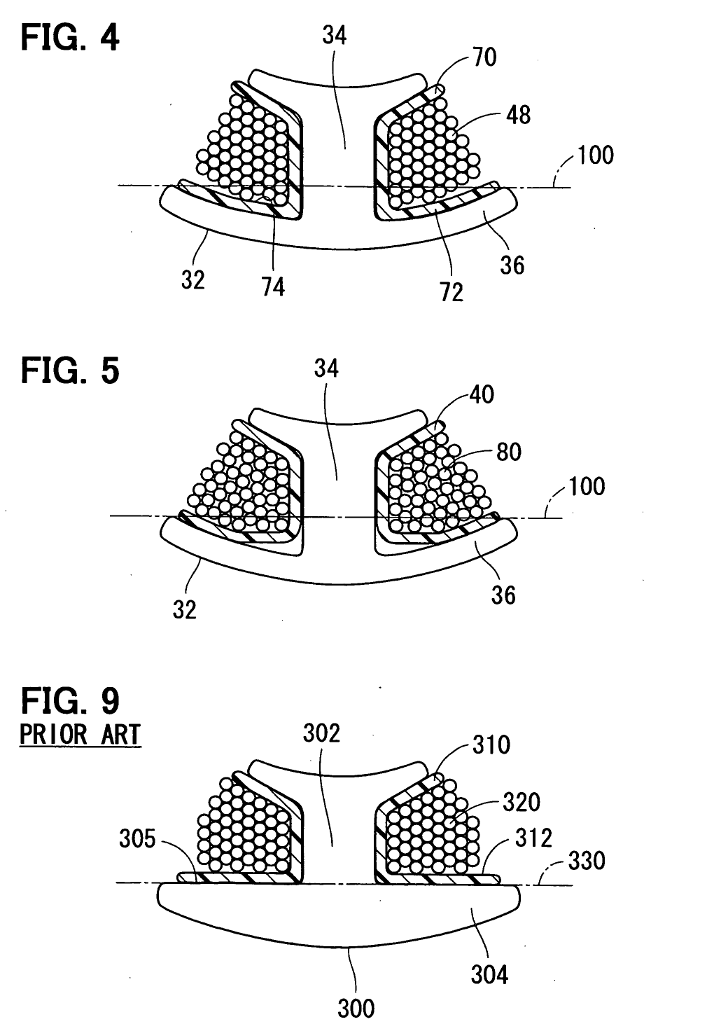

The second embodiment of the present invention is shown in FIG. 4, and the third embodiment of the present invention is shown in FIG. 5. Here, substantially identical components identical with those of the first embodiment will be denoted by the same numerals.

In the second embodiment shown in FIG. 4, outer collars 72 located on an outer peripheral core 36 side of an insulator 70 have arcuate shapes, which extend along the outer peripheral core 36 from both circumferential ends toward the tooth 34. Also, a tooth 34 side of a coil winding surface 74, which is a radially inner surface of each outer collar 72, is positioned radially outward of the imaginary straight line 100. Also, tooth 34 sides of the coil winding surfaces 74 of the outer collars 72 are not flat surfaces in contrast to the first embodiment. The coil winding surfaces 74 have recessed arcuate shapes, which extend from corresponding circumferential ends toward the tooth 34.

In the insulator 70 formed as above, the guide surface 136 of the guide 134 the winding apparatus 120 shown in FIGS. 3 of the first embodiment corresponds to a shape of the coil winding surface 74 of the outer collar 72 of the insulator 70 of the second embodiment. Therefore, the winding wire 142 can be wound on the winding space of the insulator defined radially outward of the imaginary straight line 100 through the concentrated and normal winding.

In the third embodiment shown in FIG. 5, shapes of the coil core 32 and the insulators 40 are identical with those of the first embodiment. However, the winding wire 142, which forms a coil 80, is wound through a random winding instead of the normal winding.

In the above embodiments, the motor of the present invention applied to the fuel pump. However, the motor of the present invention is not limited to the fuel pump, but can be used as a drive source for other device.

### Fourth Embodiment

Hereinafter, the fourth embodiment of the present invention will be described with reference to drawings. Similar components of a motor of the present embodiment, which are similar to the components of the motor of the first embodiment, will be indicated by the same numerals.

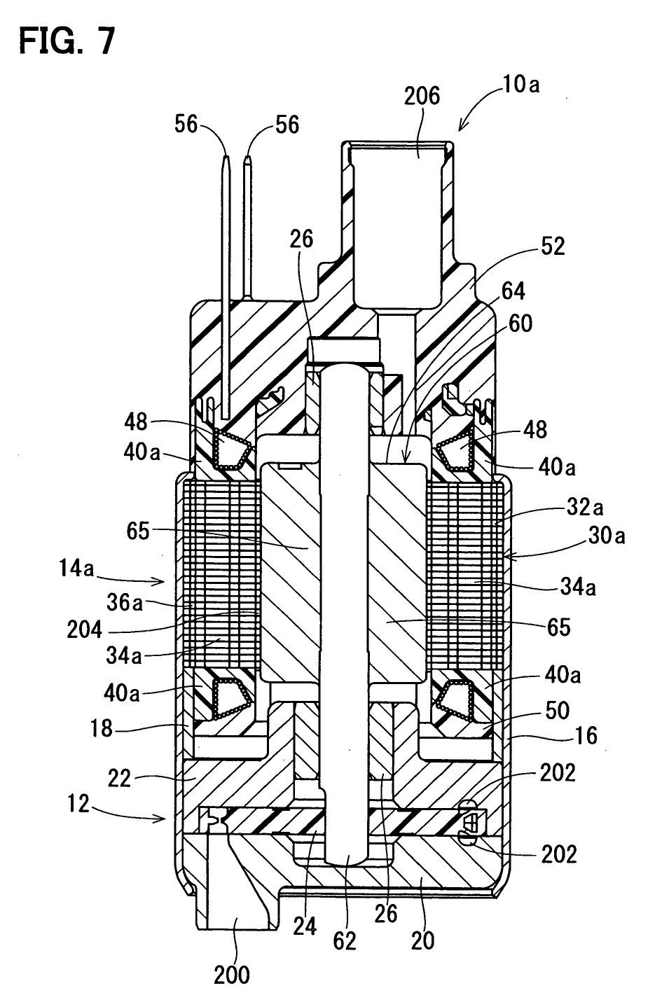

A fuel pump, which uses a motor of one embodiment of the present invention, is shown in FIG. 7. A fuel pump 10a of the present embodiment is, for example, an in-tank type turbine pump provided in a fuel tank of a two-wheeled vehicle with a cylinder capacity of equal to or less than 150 cc.

The fuel pump 10a includes a pump 12 and a motor 14a, which rotationally drives the pump 12. A housing of the fuel pump 10a is configured by housings 16, 18. Each of the housings 16, 18 is formed into a cylindrical shape by press-working sheet metal, and the housing 18 is press-fitted into the housing 16 and is fixed thereto. The housing 16 also serves as a housing for the pump 12 and the motor 14a, and is designed to have a thickness of about 0.5 mm. Both longitudinal end portions of the housing 16 caulks a pump case 20 and a stator core 30a to fix them. A pump case 22 and the stator core 30a are pressed against longitudinal ends of the housing 18 such that longitudinal positions thereof are determined.

The pump 12 is a turbine pump having the pump cases 20, 22, and an impeller 24. The pump case 22 is press-fitted into the housing 16, and is pressed against the housing 18 in a longitudinal direction. The pump cases 20, 22 are pump cases, which receives the impeller 24 as a rotatable member such that the impeller 24 is rotatable. A pump passage 202, which has a C shape, is provided at each clearance between the impeller 24 and each of the pump cases 20, 22. A pressure of fuel, which is taken through an intake port 200 provided at the pump case 20, is increased in the pump passage 202 by the rotation of the impeller 24 and then the fuel is pumped toward the motor 14a. The fuel pumped to the motor 14a flows through a fuel passage 204 located between the stator core 30a and a rotor 60 and then is supplied to an engine through a discharge port 206.

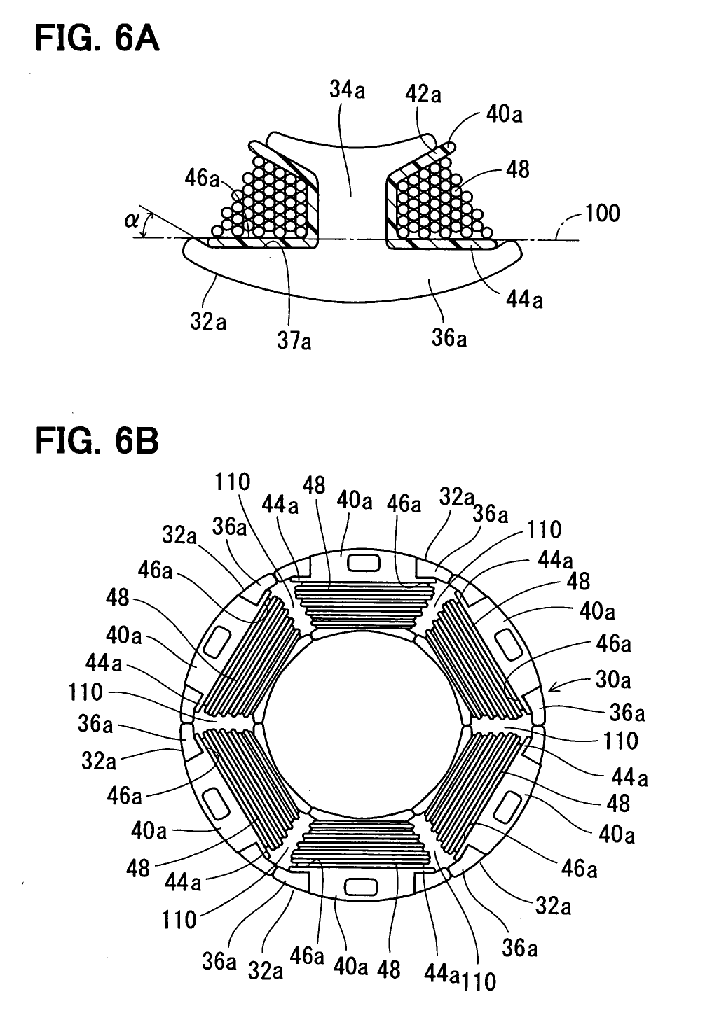

The motor 14a is a so-called brushless motor of an inner rotor type. The motor 14a includes the stator core 30a, insulators 40a, and coils 48. As shown in FIGS. 6A, 6B, the stator core 30a is configured by six coil cores 32a, which are each separated and are circumferentially arranged at regular intervals. The coil core 32a is formed by mutually caulking magnetic steel plates, which are stacked in the longitudinal direction.

The coil core 32a includes a tooth 34a, which radially extends, and an outer peripheral core 36a, which extends in both circumferential directions from a radially outer side of the tooth 34a. An outer peripheral surface of the outer peripheral core 36a has an arcuate shape, and the outer peripheral cores 36a of the six coil cores 32a form an outer peripheral portion of the stator core 30a, which has an annular shape of almost no gap therebetween. Relative to an imaginary straight line 100, which connects both circumferential ends of an inner peripheral surface 37a of the outer peripheral core 36a, both the circumferential sides of the inner peripheral surface 37a are more tilted radially inwardly as the circumferential ends approach circumferentially adjacently arranged coil cores 32a. For example, each circumferential end of the inner peripheral surface 37a is tilted radially inwardly more at a position of the inner peripheral surface 37a when the position is closer to a corresponding circumferentially adjacently arranged coil.

A tooth 34a side of the inner peripheral surface 37a of the outer peripheral core 36a is a flat surface along the imaginary straight line 100. That is, the tooth 34a side of the inner peripheral surface 37a of the outer peripheral core 36a is positioned radially outward of the imaginary straight line 100 and is recessed. The tooth 34a side of the outer peripheral core 36a is thicker than the circumferential sides of the outer peripheral core 36a, and this thick portion is an unnecessary portion for a magnetic circuit. Therefore, even when the tooth 34a side of the inner peripheral surface 37a of the outer peripheral core 36a is positioned radially outward of the imaginary straight line 100 and is recessed, a magnetic performance is not degraded. When α is defined as an tilt angle, at which the circumferential ends of the inner peripheral surface 37a of the outer peripheral core 36a are more tilted radially inwardly as the circumferential ends approach circumferentially adjacently arranged coil cores 32a relative to the imaginary straight line 100, α is designed to have relation of 25 °≦α≦35° in the present embodiment.

A pair of insulators 40a are formed to have substantially the same shape. The pair of insulators 40a are fitted with a corresponding coil core 32a from both longitudinal ends thereof and are mounted on the coil core 32a. Each insulator 40a has inner collars 42a on a radially inner side thereof, and outer collars 44a on a radially outward side thereof to form winding spaces defined between the inner collar 42a and the outer collar 44a as shown in FIG. 6A. The coil 48 is formed by winding the winding wire in these winding spaces. The outer collar 44a is provided at a flat surface portion, which is the inner peripheral surface 37a of the outer peripheral core 36a, and is radially outwardly recessed relative to the imaginary straight line 100.

A coil winding surface 46a is a radially inside surface of each outer collar 44a, and is a flat surface extending along the imaginary straight line 100, and the imaginary straight line 100 is positioned on the coil winding surface 46a. That is, a position of the opening of the outer peripheral core 36a generally coincides with a position of an opening of the outer collar 44a of the insulator 40a (an outer peripheral core side of the opening position of the coil core generally coincides with an outer peripheral core side of an opening position of the insulator). Therefore, the winding wire can be easily wound along the coil winding surface 46a of the outer collar 44a from the opening on the outer peripheral core 36a side of the coil core 32a. The coil 48 is formed by a concentrated and normal winding of the winding wire on the insulator 40a of each coil core 32a.

As shown in FIG. 7, dielectric resin material 50 covers the stator core 30a, the insulators 40a, and the coils 48 except for a radially inner surface and a radially outer surface of the stator core 30a. An end cover 52 is integrally resin molded with the dielectric resin material 50 to form the discharge port 206. The terminals 56, which are exposed from the end cover 52 and is insert-molded therewith, are electrically connected with the coils 48.

The rotor 60 includes a shaft 62 and a permanent magnet 64, and is provided inside the stator core 30a such that the rotor 60 is rotatable. Both end portions of the shaft 62 are rotatably supported by bearings 26. The permanent magnet 64 is a plastic magnet, which is made by incorporating magnetic powders into thermoplastic resin, such as a polyphenylene sulfide (PPS), and a polyacetal (POM), to form a cylindrical shape. The permanent magnet 64 has eight magnetic portions 65 in a rotational direction. The eight magnetic portions 65 are polarized such that different magnetic poles are alternately formed in the rotational direction on outer peripheral surface sides thereof, which face the coil cores 32a.

Relative to the rotor 60, which has the above polarized permanent magnet 64, a control device (not shown) switches energization of the coil 48 wound on each coil core 32a to switch magnetic poles generated on inner peripheral surface sides of the coil cores 32a, which constitute the stator core 30a, in the order of a circumferential direction such that the rotor 60 rotates.

Next, a winding process for winding the winding wire, which forms the coil 48, will be described.

(1) Firstly, the coil core 32a is formed by mutually caulking magnetic steel plates, which are stacked in the longitudinal direction.

(2) The insulators 40a are fitted with the corresponding coil core 32a from both longitudinal direction end sides of the coil core 32a for assembly. In this state, the position of the opening of the outer peripheral core 36a generally coincides with the position of the opening of the outer collar 44a of the insulator 40a.

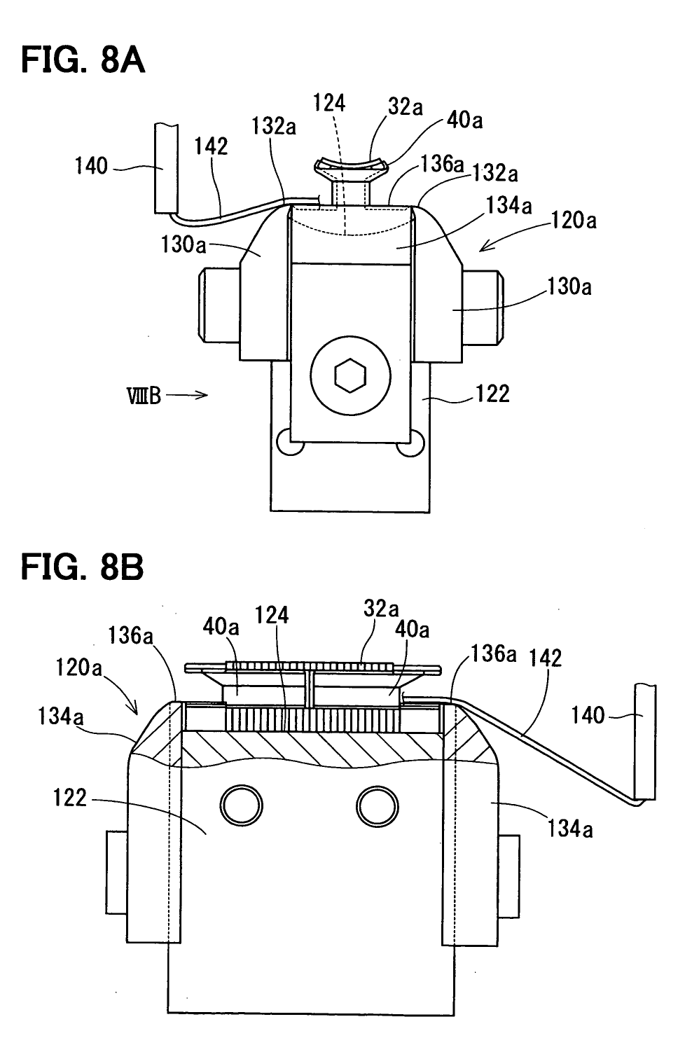

(3) The coil core 32a, which is assembled with the insulators 40a, is mounted on a base 122 of a winding apparatus 120a shown in FIGS. 8A, 8B in a condition where the outer peripheral core 36a faces downward. A mounting surface 124 of the base 122, on which the coil core 32a is mounted, has a recessed arcuate surface, which corresponds to a protruding arcuate surface of the outer peripheral surface of the outer peripheral core 36a. Guides 130 are fixed on both transverse end sides of the base 122, and guides 134 are fixed on both longitudinal end sides of the base 122. A guide surface 132a on a top end of the guide 130a extends straightly in the longitudinal direction of the coil core 32a, and is formed to have a smooth protruding curved surface to a winding wire 142 in order to guide the winding wire 142. Also, a guide surface 136a on a top end of the guide 134a has a straight shape generally along the coil winding surface 46a of the outer collar 44a of the insulator 40a. Also, the guide surface 136a is formed to have a smooth protruding curved surface to the winding wire 142 in order to guide the winding wire 142.

(4) After mounting the coil core 32a assembled with the insulators 40a on the base 122, the a nozzle 140, which supplies the winding wire 142, is brought close to the coil core 32a.

(5) Then, as shown in FIG. 3A, in a condition where the winding wire 142 is kept under tension in contact with the guide surface 1 32a on the top end of the guide 130a, the nozzle 140 is moved in the longitudinal direction of the coil core 32a. When the nozzle 140 reaches one longitudinal end side of the coil core 32a, the winding wire 142 is moved from the guide surface 132a of the guide 130a to the guide surface 136a of the guide 134a. Then, in a condition where the winding wire 142 is kept under tension in contact with the guide surface 136a on the top end of the guide 134a, the winding wire 142 is wound.

In this way, the winding wire 142 is wound on the insulator 40a, which is assembled to each coil core 32a, through the concentrated and regular winding.

In the above described embodiments, the circumferential ends of the inner peripheral surface 37a are tilted radially inwardly relative to the imaginary straight line 100 as the circumferential ends approach circumferentially adjacently arranged coil cores 32a. That is, the tooth 34a side of the inner peripheral surface 37a of the outer peripheral core 36a is recessed radially outward of the imaginary straight line 100. Therefore, the coil winding surface 46a of the insulator 40a, which covers the coil core 32a, on the outer peripheral core 36a side thereof can be more radially outwardly provided, and as a result, the motor 14a of the fuel pump 10a can be decreased in size, and the winding space, which is formed by the insulator 40a, can be increased. Thus, for the same number of turns, both circumferential end positions of the coil 48, which is wound on each coil core 32a, can be displaced toward the tooth 34a. Thus, because a clearance 110 between the coils adjacently arranged in the circumferential direction can be larger as shown in FIGS. 6A, 6B, insulation fault between the coils adjacently arranged in the circumferential direction can be limited. Also, because the winding space becomes larger, the circumferentially adjacently arranged coils are limited from being located excessively close to each other and still the number of turns can be increased. Thus, the motor efficiency can be improved. Because the above described motor is used, a fuel pump using the motor can be decreased in size.

In the above embodiment, tilt angle α, which is a tilt of both circumferential sides of the inner peripheral surface 37a of the outer peripheral core 36a relative to the imaginary straight line 100, is designed as 25°≦α≦35° in a condition where the six coil cores 32a constitute the stator core 30a. The tilt angle α decreases when the number of the coil cores, which constitute the stator core, increases and a circumferential length of the outer peripheral core is shortened. Also, the tilt angle α increases when the number of the coil cores decreases and the circumferential length of the outer peripheral core is elongated. For example, in a case where the number of the coil cores is four, α is set as 40°≦α≦50°, and in a case where the number of the coil cores is four, α is set as 17.5°≦α≦27.5°.

Here, the tilt angle α is not limited to the above described range, however, the tilt angle may be any magnitude as long as the circumferential ends of an inner peripheral surface of the outer peripheral core are more tilted radially inwardly relative to the imaginary straight line that connects the circumferential ends of the inner peripheral surface of the outer peripheral core as the circumferential ends approach circumferentially adjacently arranged coil cores.

Also, in order to decrease the size of the motor and still to increase the winding space of the coil, the circumferential sides of the inner peripheral surface of the outer peripheral core are not necessarily more tilted radially inwardly relative to the imaginary straight line, which connects the circumferential ends of the inner peripheral surface of the outer peripheral core, as the circumferential ends approach circumferentially adjacently arranged coil cores. However, a tooth side of the inner peripheral surface of the outer peripheral core may be recessed radially outwardly relative to the imaginary straight line, which connects the circumferential ends of the inner peripheral surface of the outer peripheral core.

Also, in the above embodiment, the motor of the present invention applied to the fuel pump. However, the motor of the present invention is not limited to the fuel pump, but can be used as a drive source for other device.

Also, in the above embodiment, the winding wire is normally wound to form the coil 48. However, the winding wire may be randomly wound to form a coil.

Thus, the present invention is not limited to the above embodiments, but can be applied to various embodiments as long as gist is not deviated.

Additional advantages and modifications will readily occur to those skilled in the art. The invention in its broader terms is therefore not limited to the specific details, representative apparatus, and illustrative examples shown and described.

What is claimed is:

1. A motor comprising:
a stator core that includes a plurality of coil cores, which are circumferentially arranged, wherein each of the plurality of coil cores includes:
a tooth that radially extends; and
an outer peripheral core that circumferentially extends at a radially outer side of the tooth;
insulators, each of which covers a corresponding one of the plurality of coil cores, wherein a part of each of the insulator is provided radially outward of an imaginary straight line, which connects circumferential ends of an inner peripheral surface of the outer peripheral core;
coils, each of which is formed by winding a winding wire at an outer periphery of a corresponding one of the insulators, wherein a magnetic pole, which is circumferentially formed at a radially inner side of each of the plurality of coil cores, is switched when energization of a corresponding one of the coils is controlled; and
a rotor that is rotatably provided to an inner peripheral side of the stator core, wherein:
different magnetic poles are alternately arranged in a rotational direction on an outer peripheral surface of the rotor; and
the outer peripheral surface of the rotor faces the stator core.

2. The motor according to claim 1, wherein:
a tooth side of the inner peripheral surface of the outer peripheral core is positioned radially outward of the imaginary straight line; and
a tooth side of an outer peripheral core side of a coil winding surface of the insulator is positioned radially outward of the imaginary straight line.

3. The motor according to claim 2, wherein:
the tooth side of the outer peripheral core side of the coil winding surface is a flat surface that extends along the imaginary straight line.

4. A fuel pump comprising:
the motor according to claim 1; and
a pump that is driven by the motor, wherein the pump takes in fuel and increases pressure of the fuel.

5. A motor comprising:
a stator core that includes a plurality of coil cores, which are circumferentially arranged, wherein:
each of the plurality of coil cores includes:
a tooth that radially extends; and
an outer peripheral core that circumferentially extends at a radially outer side of the tooth; and
circumferential ends of an inner peripheral surface of the outer peripheral core are more tilted radially inwardly relative to an imaginary straight line that connects the circumferential ends of the inner peripheral surface of the outer peripheral core as the circumferential ends approach circumferentially adjacently arranged coil cores;
insulators, each of which covers a corresponding one of the plurality of coil cores, wherein an outer peripheral core side of a coil winding surface of each of the insulators extends generally along the imaginary straight line;
coils, each of which is wound on a corresponding one of the insulators; and
a rotor that is rotatably provided to an inner peripheral side of the stator core, wherein:
different magnetic poles are alternately arranged in a rotational direction on an outer peripheral surface of the rotor; and
the outer peripheral surface of the rotor faces the stator core.

6. The motor according to claim 5, wherein the imaginary straight line is positioned on an outer peripheral core side of the coil winding surface.

7. The motor according to claim 5, wherein:
α is defined as a tilt angle, at which the circumferential ends of inner peripheral surface of the outer peripheral core are tilted radially inwardly relative to the imaginary straight line that connects the circumferential ends of the inner peripheral surfaces of the outer peripheral core as the circumferential ends approach circumferentially adjacently arranged coil cores;
when the coil cores are four coil cores, 40a°≦α≦50°;
when the coil cores are six coil cores, 25°≦α≦35°; and
when the coil cores are eight coil cores, 17.5°≦α≦27.5°.

8. A fuel pump comprising:
the motor according to claim 5; and
a pump that is driven by the motor, wherein the pump takes in fuel and increases pressure of the fuel.

9. A motor comprising:
a stator core that includes a plurality of coil cores that are circumferentially arranged, wherein:
each of the plurality of coil cores includes:
a tooth that radially extends; and
an outer peripheral core that circumferentially extends at a radially outer side of the tooth; and
a tooth side of an inner peripheral surface of the outer peripheral core is recessed radially outwardly relative to an imaginary straight line that connects the circumferential ends of the inner peripheral surfaces of the outer peripheral core as the circumferential ends approach circumferentially adjacently arranged coil cores;
insulators, each of which covers a corresponding one of the plurality of coil cores, wherein an outer peripheral core side of a coil winding surface of each of the insulators extends generally along the imaginary straight line;
coils, each of which is wound on a corresponding one of the insulators; and
a rotor that is rotatably provided to an inner peripheral side of the stator core, wherein:
different magnetic poles are alternately arranged in a rotational direction on an outer peripheral surface of the rotor; and
the outer peripheral surface of the rotor faces the stator core.

10. A fuel pump comprising:
the motor according to claim 9; and
a pump that is driven by the motor, wherein the pump takes in fuel and increases pressure of the fuel.
